(19) United States
(12) Patent Application Publication
(10) Pub. No.: US 2026/0267346 A1
(43) Pub. Date: Sep. 10, 2026

(54) VEHICLE DRIVING ASSISTANCE APPARATUS

(71) Applicants: TOYOTA JIDOSHA KABUSHIKI KAISHA, Aichi (JP); DENSO CORPORATION, Aichi-pref. (JP)

(72) Inventor: Keishi YOSHIMURA, Susono-shi (JP)

(21) Appl. No.: 19/554,645

(22) Filed: Mar. 3, 2026

(30) Foreign Application Priority Data
Mar. 7, 2025 (JP) 2025-036231

(51) Int. Cl. G05D 1/633; B60W 30/09

(52) U.S. Cl. CPC G05D 1/633; B60W 30/09; B60W 2554/80

(57) ABSTRACT

A vehicle driving assistance apparatus including an electronic control unit that, when it is determined that an avoidance target to be avoided by collision avoidance exists within a predetermined range diagonally forward of an own vehicle, determines repeatedly a target passing point laterally spaced from the avoidance target by a target avoidance distance for avoiding a collision, sets a target travelling route to pass through the target passing point, and executes driving assistance control to perform steering control such that the own vehicle travels along the target travelling route. When it is determined that the target passing point has changed by at least a reference distance in at least the lateral direction of the road relative to a position at which the target travelling route was set previously, the electronic control unit resets the target travelling route so as to pass through the changed target passing point.

### CROSS-REFERENCE TO RELATED APPLICATION

This application claims priority to Japanese Patent Application No. JP2025-036231 filed on Mar. 7, 2025, the content of which is hereby incorporated by reference in its entirety into this application.

### BACKGROUND

### 1. Technical Field

The present disclosure relates to a driving assistance apparatus for a vehicle such as an automobile, and more particularly to a vehicle driving assistance apparatus that avoids a collision between the vehicle and an object present diagonally forward of the vehicle.

### 2. Description of the Related Art

As one type of driving assistance apparatus, there is known a driving assistance apparatus that, when an avoidance target to be avoided by collision avoidance is present diagonally forward of a vehicle, sets a target travelling route so that the vehicle passes through a target passing point laterally spaced from the avoidance target in a lateral direction of a road, and performs steering control so that the vehicle travels along the target travelling route.

For example, Japanese Laid-open Patent Publication No. 2020-66300 describes a driving assistance apparatus configured such that, when avoidance targets are present ahead on both left and right sides of a vehicle and a distance between the two avoidance targets in a direction along the road is equal to or less than a reference value, a distance between the avoidance target closer to the vehicle and a target passing point is made smaller as compared to where the distance between the two avoidance targets exceeds the reference value.

In a driving assistance apparatus that sets a target travelling route for collision avoidance, if the target travelling route is not reset even when an avoidance target moves in a direction crossing the road, it is impossible to appropriately avoid a collision with the avoidance target without an occupant or occupants of a vehicle feeling anxiety or the like.

Conversely, when a target passing point is determined and a target travelling route is set at every predetermined control cycle, the target travelling route is also set even when the avoidance target is stationary or when an amount of movement of the avoidance target in the direction crossing the road is very small. As a result, computational load of a control device required to set the target travelling route becomes excessive.

### SUMMARY

The present disclosure provides an improved driving assistance apparatus that is capable of appropriately avoiding a collision with an avoidance target even when the avoidance target moves in a direction crossing a road, while avoiding an excessive computational load of a control device.

According to the present disclosure, there is provided a vehicle driving assistance apparatus comprising: an object information acquisition device configured to repeatedly acquire object information ahead of an own vehicle; and an electronic control unit configured to, when the electronic control unit determines based on the information acquired by the object information acquisition device that an avoidance target to be avoided by collision avoidance exists within a predetermined range diagonally forward of the own vehicle, determine a target passing point laterally spaced from the avoidance target by a target avoidance distance for avoiding a collision, set a target travelling route to pass through the target passing point, and execute driving assistance control to perform steering control such that the own vehicle travels along the target travelling route.

The control unit is configured such that, when the electronic control unit determines that the target passing point has changed by at least a reference distance in at least a lateral direction of a road relative to a position at which the target travelling route was set previously, the electronic control unit resets the target travelling route so as to pass through the changed target passing point.

With the above configuration, when it is determined that the target passing point has changed by at least the reference distance in at least the lateral direction of the road relative to the position at which the target travelling route was set previously, the target travelling route is reset so as to pass through the changed target passing point. Accordingly, when the avoidance target moves by at least a distance corresponding to the reference distance in at least the lateral direction of the road, the target travelling route can be reset. Therefore, it is possible to prevent an occupant or occupants of the own vehicle from feeling anxiety due to an inappropriate avoidance of the avoidance target caused by the target travelling route not being reset even though the avoidance target has moved by at least the distance corresponding to the reference distance in at least the lateral direction of the road.

Further, as compared with where the target passing point is determined and the target travelling route is reset at each predetermined control cycle, a frequency of resetting the target travelling route can be reduced, thereby reducing the computational load of the control unit required to set the target travelling route.

Furthermore, the target passing point at the time of previously setting the target travelling route is a point on the currently set target travelling route, and whether resetting the target travelling route is necessary is determined based on a movement distance of the point. Therefore, the determination of whether resetting of the target travelling route is necessary can be made more easily as compared to where the necessity of resetting the target travelling route is determined based on a change in position of the avoidance target.

Herein, an “avoidance target” is an object with which the own vehicle may collide and for which it is necessary to avoid a collision by traveling while moving in the lateral direction of the road while travelling.

In one aspect of the present disclosure, the electronic control unit is configured to, when the electronic control unit determines that a plurality of avoidance targets exist on one of left and right sides relative to the own vehicle, determine the target passing point for an avoidance target having a smallest time to collision among time to collisions calculated based on distances and relative speeds between the own vehicle and the plurality of avoidance targets.

When a plurality of avoidance targets exist on one of the left and right sides relative to the own vehicle, there is a high possibility that the own vehicle will first collide with the avoidance target having the smallest TTC among the plurality of avoidance targets. Therefore, it is preferable that the target travelling route be set so as not to collide with the avoidance target having the smallest TTC.

According to the above aspect, when it is determined that a plurality of avoidance targets exist on one of the left and right sides relative to the own vehicle, the target passing point is determined for the avoidance target having the smallest TTC. Accordingly, the target passing point can be determined for the avoidance target with which a collision is most likely to occur first, and the target travelling route can be set so as to pass through the target passing point.

In another aspect of the present disclosure, the electronic control unit is configured such that, when the electronic control unit determines that avoidance targets exist on both left and right sides relative to the own vehicle, the electronic control unit determines target passing points for the avoidance targets on both sides and sets the target travelling route to pass through the two determined target passing points, when a difference in time to collision calculated based on a distance and a relative speed between the own vehicle and the avoidance targets on both sides is greater than a reference value.

When avoidance targets exist on both left and right sides, directions in which the own vehicle avoids collisions with the left and right avoidance targets are opposite to each other. Therefore, when a distance along the road between the left and right avoidance targets is small, it is not possible to set a target travelling route that passes through target passing points for both avoidance targets.

According to the above aspect, when avoidance targets exist on both left and right sides relative to the own vehicle, target passing points for the avoidance targets on both sides are determined and the target travelling route is set so as to pass through the two determined target passing points when the difference in TTC is greater than the reference value. Accordingly, a target travelling route for the own vehicle to travel avoiding the avoidance targets on both sides can be set.

In yet another aspect of the present disclosure, the electronic control unit is configured to determine the target passing points for the avoidance targets on both sides, when the difference in time to collision is equal to or less than the reference value, and the electronic control unit is further configured to set the target travelling route so as to pass through a midpoint between the two determined target passing points and, in a region between the two target passing points, extend along the road, when a width of overlap between ranges of the target avoidance distances for the avoidance targets on both sides is equal to or less than a reference width determined based on a width of the road and a width of the own vehicle.

According to the above aspect, when the difference in TTC is equal to or less than the reference value and the width of overlap between ranges of the target avoidance distances is equal to or less than the reference width, the target travelling route is set to pass through the midpoint between the two target passing points and extend along the road in the region between the two target passing points. Accordingly, a target travelling route that avoids the avoidance targets on both sides as much as possible can be set to extend along the road without sharply weaving.

The reference width (Warlc) may be variably set according to at least one of a width of the road and a width of the own vehicle such that the reference width becomes smaller as the road width becomes smaller and becomes smaller as the width of the own vehicle becomes larger.

In yet another aspect of the present disclosure, the electronic control unit is configured to set the target travelling route so as to pass through the midpoint between the two determined target passing points and, in the region between the two target passing points, extend along the road, and to decelerate the own vehicle, when the width of overlap between the ranges of the target avoidance distances for the avoidance targets on both sides is greater than the reference width.

According to the above aspect, when the width of overlap between the ranges of the target avoidance distances is greater than the reference width, the target travelling route is set to pass through the midpoint between the two target passing points and extend along the road in the region between the two target passing points, and the own vehicle is decelerated. Accordingly, the target travelling route can be set to extend along the road without sharply weaving while avoiding the avoidance targets on both sides as much as possible, and it is possible to prevent the own vehicle from approaching the avoidance targets or colliding therewith at a high vehicle speed.

In yet another aspect of the present disclosure, the electronic control unit is configured to determine, based on the information acquired by the object information acquisition device, a movement direction of the avoidance target in a lateral direction of the road, and to increase the target avoidance distance when the movement direction of the avoidance target is a direction approaching an opposite side of the road, as compared with when the movement direction of the avoidance target is a direction moving away from the opposite side of the road.

When the avoidance target moves in a direction approaching a planned travel path of the own vehicle, it is preferable that the target avoidance distance for avoiding a collision be larger than when the avoidance target moves in a direction away from the planned travel path of the own vehicle.

According to the above aspect, when the movement direction of the avoidance target is a direction approaching the opposite side of the road, the target avoidance distance is made larger than when the movement direction of the avoidance target is a direction moving away from the opposite side of the road. Accordingly, it is possible to effectively avoid a collision with the avoidance target by increasing the target avoidance distance when the avoidance target moves in the direction approaching the opposite side of the road, without excessively increasing the target avoidance distance when the avoidance target moves in the direction moving away from the opposite side of the road.

In yet another aspect of the present disclosure, the electronic control unit is configured to estimate, based on the information acquired by the object information acquisition device, a movement speed of the avoidance target in the lateral direction of the road, and to variably set the target avoidance distance according to the movement speed such that the target avoidance distance increases as the movement speed increases.

When the avoidance target moves laterally across the road so as to approach the planned travel path of the own vehicle, a larger movement speed of the avoidance target is more likely to cause delay in setting and resetting the target travelling route. Therefore, it is preferable that the target avoidance distance be larger as the speed at which the avoidance target moves laterally across the road increases.

According to the above aspect, the lateral movement speed of the avoidance target is estimated in the lateral direction of the road, and the target avoidance distance is variably set according to the movement speed such that the target avoidance distance increases as the movement speed increases. Accordingly, it is possible to effectively avoid a collision with the avoidance target without delay by increasing the target avoidance distance when the movement speed of the avoidance target is large, without excessively increasing the target avoidance distance when the movement speed is small.

In yet another aspect of the present disclosure, the electronic control unit is configured to variably set the target avoidance distance according to the movement direction and the movement speed of the avoidance target such that an increase rate of the target avoidance distance with respect to an increase in the movement speed is smaller than when the movement direction of the avoidance target is a direction approaching the opposite side of the road, when the movement direction of the avoidance target is a direction moving away from the opposite side of the road.

When the avoidance target approaches the opposite side of the road, that is, when the avoidance target approaches the planned travel path of the own vehicle, it is preferable to move the target travelling route away from the avoidance target without delay. Therefore, it is preferable that a temporal rate at which the target avoidance distance increases as the movement speed of the avoidance target increases be high. Conversely, when the avoidance target moves away from the opposite side of the road, that is, when the avoidance target moves away from the planned travel path of the own vehicle, it is preferable to avoid causing the occupant or occupants of the own vehicle to feel anxiety that the own vehicle will approach the avoidance target too closely. Therefore, it is preferable that a temporal rate at which the target avoidance distance increases as the movement speed of the avoidance target increases not be high.

According to the above aspect, when the movement direction of the avoidance target is a direction moving away from the opposite side of the road, the avoidance distance is variably set such that the increase rate of the target avoidance distance with respect to an increase in movement speed is smaller than when the movement direction is a direction approaching the opposite side of the road. Accordingly, when the movement direction of the avoidance target is a direction moving away from the opposite side of the road, it is possible to reduce a possibility that the occupant or occupants of the own vehicle will feel anxiety that the own vehicle will approach the avoidance target too closely, and when the movement direction is a direction approaching the opposite side of the road, it is possible to move the target travelling route away from the avoidance target without delay.

Other objects, other features, and accompanying advantages of the present disclosure will be readily understood from the following description of embodiments of the present disclosure with reference to the accompanying drawings.

### BRIEF DESCRIPTION OF THE DRAWINGS

FIG. 1 is a schematic configuration diagram illustrating a vehicle driving assistance apparatus according to an embodiment.

FIG. 2 is a flowchart corresponding to a driving assistance control program for collision avoidance in the embodiment.

FIG. 3 is a flowchart illustrating a subroutine for determining an avoidance distance Lar executed in step S70 of FIG. 2.

FIG. 4 is a flowchart illustrating a subroutine for determining an avoidance distance Lal executed in step S120 of FIG. 2.

FIG. 5 is a flowchart illustrating a subroutine of steering control for collision avoidance for avoidance targets on both left and right sides executed in step S200 of FIG. 2.

FIG. 6 is a graph corresponding to a map for calculating a target avoidance distance Lar based on a movement speed Vayr of an avoidance target.

FIG. 7 is a graph corresponding to a map for calculating a target avoidance distance Lal based on a movement speed Vayl of an avoidance target.

FIG. 8 illustrates a situation in which one stationary avoidance target exists diagonally forward to the left of the own vehicle.

FIG. 9 illustrates a situation in which one avoidance target moving rightward exists diagonally forward to the left of the own vehicle.

FIG. 10 illustrates a situation in which one avoidance target moving leftward exists diagonally forward to the left of the own vehicle.

FIG. 11 illustrates a situation in which two stationary risk targets exist in front-and-rear positions diagonally forward to the left of the own vehicle.

FIG. 12 illustrates a situation in which avoidance targets exist diagonally forward on both left and right sides of the own vehicle and a distance along a travel lane between the two avoidance targets is large.

FIG. 13 illustrates a situation in which a range of an avoidance distance Lar for a left front avoidance target and a range of an avoidance distance Lal for a right far avoidance target do not overlap.

FIG. 14 illustrates a situation in which the ranges of Lar and Lal overlap slightly.

FIG. 15 illustrates a situation in which the ranges of Lar and Lal overlap substantially.

FIG. 16 illustrates a situation in which a stationary risk target (avoidance target) exists diagonally forward to the left of the own vehicle and a stationary risk target (non-avoidance target) exists diagonally forward to the right of the own vehicle.

### DETAILED DESCRIPTION

Hereinafter, with reference to the accompanying drawings, a vehicle driving assistance apparatus according to an embodiment of the present disclosure, configured for a country where vehicles travel on the left side of a road, will be described in detail.

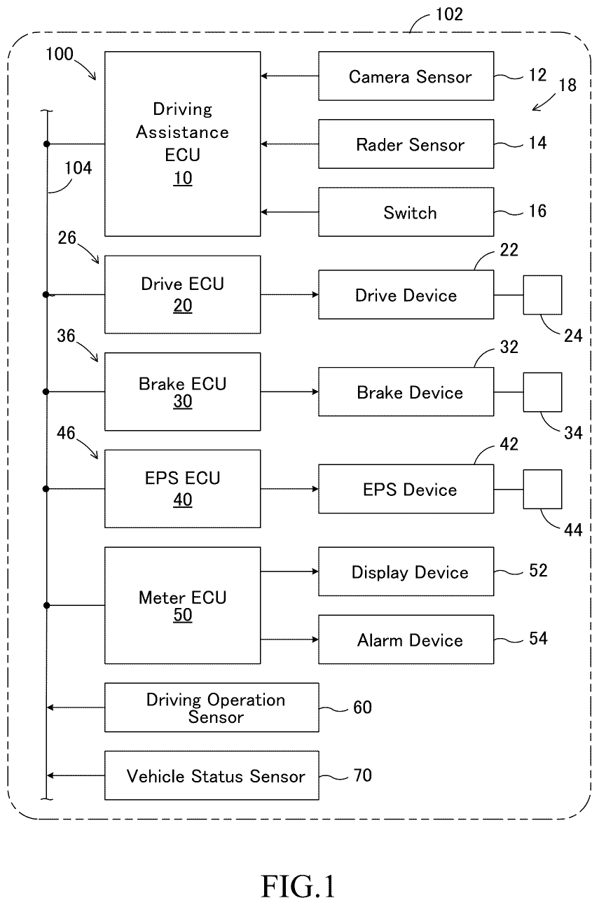

As illustrated in FIG. 1, a driving assistance apparatus 100 according to an embodiment of the present disclosure is applied to a vehicle 102 and includes a driving assistance ECU 10. The vehicle 102 may be a vehicle capable of autonomous driving and includes a drive ECU 20, a brake ECU 30, an EPS ECU 40, and a meter ECU 50. “ECU” means an electronic control unit mainly including a microcomputer, and “EPS” means electric power steering. The vehicle 102 is referred to as an own vehicle 102 as necessary to distinguish it from other vehicles.

The microcomputer of each ECU includes, for example, a CPU, a ROM, a RAM, a readable/writable nonvolatile memory (N/M), and an interface (I/F). The CPU implements various functions by executing instructions (programs, routines) stored in the ROM. Further, these ECUs are connected to each other via a CAN (Controller Area Network) 104 so as to be capable of exchanging data (communicating). Accordingly, detection values of sensors (including switches) connected to a specific ECU are transmitted also to other ECUs.

The driving assistance ECU 10 is a central control unit that performs driving assistance control such as driving assistance control for collision avoidance and following-distance control. When the driving assistance ECU 10 determines that an avoidance target that may collide with the own vehicle and should be avoided by collision avoidance exists diagonally forward of the own vehicle, the driving assistance ECU 10 determines a target passing point laterally spaced from the avoidance target by a target avoidance distance determined based on a positional relationship between the avoidance target and the own vehicle. Further, the driving assistance ECU 10 sets a target travelling route so as to pass through the target passing point and executes steering control for collision avoidance by controlling an automatic steering device described later so that the vehicle travels along the target travelling route.

A camera sensor 12, a radar sensor 14, and a switch 16 are connected to the driving assistance ECU 10. The camera sensor 12 and the radar sensor 14 each include a plurality of camera devices and a plurality of radar devices, respectively. The camera sensor 12 and the radar sensor 14 function as an object information acquisition device 18 that acquires object information around the vehicle 102.

Each camera device of the camera sensor 12 includes (not shown) a camera unit that captures images of surroundings of the vehicle 102 and a recognition unit that analyzes image data obtained by the camera unit and recognizes objects such as lane markings and other vehicles. The recognition unit supplies information about recognized objects to the driving assistance ECU 10 at each predetermined control cycle.

Each radar device of the radar sensor 14 detects, using millimeter-wave radio waves, a distance between the own vehicle and a three-dimensional object, a relative speed between the own vehicle and the three-dimensional object, a relative position (direction) of the three-dimensional object with respect to the own vehicle, and supplies information representing these to the driving assistance ECU 10 at each predetermined control cycle. Instead of the radar sensor 14, or in addition to the radar sensor 14, LiDAR (Light Detection And Ranging) may be used.

The switch 16 is provided at a position operable by a driver, such as a steering wheel not shown in FIG. 1, and is operated by the driver. Although not shown in FIG. 1, the switch 16 includes a collision-avoidance driving assistance control switch. The driving assistance ECU 10 executes collision-avoidance driving assistance control when the collision-avoidance driving assistance control switch is ON.

A drive apparatus 22 that accelerates the vehicle 102 by applying driving force to drive wheels 24 is connected to the drive ECU 20. Under normal conditions, the drive ECU 20 controls the drive apparatus 22 such that the driving force generated by the drive apparatus 22 changes according to a driver's driving operation. When the drive ECU 20 receives a command signal from the driving assistance ECU 10, the drive ECU 20 controls the drive apparatus 22 based on the command signal. Accordingly, the drive ECU 20 and the drive apparatus 22 cooperate to function as a drive control device 26.

A brake apparatus 32 that decelerates the vehicle 102 by braking by applying braking force to wheels 34 is connected to the brake ECU 30. Under normal conditions, the brake ECU 30 controls the brake apparatus 32 such that braking force generated by the brake apparatus 32 changes according to a driver's braking operation. When the brake ECU 30 receives a command signal from the driving assistance ECU 10, the brake ECU 30 performs automatic braking by controlling the brake apparatus 32 based on the command signal.

Accordingly, the brake ECU 30 and the brake apparatus 32 cooperate to function as a brake control device 36. When braking force is applied to the wheels due to travel control or the like, brake lamps (not shown in FIG. 1) are turned on.

An EPS apparatus 42 is connected to the EPS ECU 40. The EPS ECU 40 controls the EPS apparatus 42 in a manner known in the art based on steering torque and vehicle speed, thereby controlling steering assist torque and reducing a driver's steering burden. Further, the EPS ECU 40 can steer steered wheels 44 as necessary by controlling the EPS apparatus 42. Accordingly, the EPS ECU 40 and the EPS apparatus 42 cooperate to function as an automatic steering device 46.

A display device 52 that displays a control status of the driving assistance ECU 10 and an alarm device 54 that issues an alarm are connected to the meter ECU 50. The display device 52 may be, for example, a multi-information display on which meters and various information are displayed, and may be a display of a navigation device (not shown). As described later, when the display device 52 receives a signal from the driving assistance ECU 10, the display device 52 displays a status of driving assistance control.

The alarm device 54 is activated when it is determined that the own vehicle 102 may collide with an avoidance target such as a pedestrian, a bicycle, or another vehicle, and issues an alarm indicating that the own vehicle may collide with the avoidance target. The alarm device 54 may be any of a visual alarm device such as an alarm lamp, an audible alarm device such as an alarm buzzer, and a haptic alarm device such as a seat vibration, or any combination thereof.

A driver operation sensor 60 and a vehicle state sensor 70 are also connected to the CAN 104. Information detected by the driver operation sensor 60 and the vehicle state sensor 70 (referred to as sensor information) is transmitted to the CAN 104. The sensor information transmitted to the CAN 104 is available for use by each ECU as appropriate. The sensor information may be information from a sensor connected to a specific ECU and may be transmitted to the CAN 104 from that specific ECU.

The driver operation sensor 60 includes, for example, a steering angle sensor that detects a steering angle, a steering torque sensor, and the like. The vehicle state sensor 70 includes, for example, a vehicle speed sensor that detects vehicle speed V, a longitudinal acceleration sensor, a lateral acceleration sensor, a yaw rate sensor, and the like.

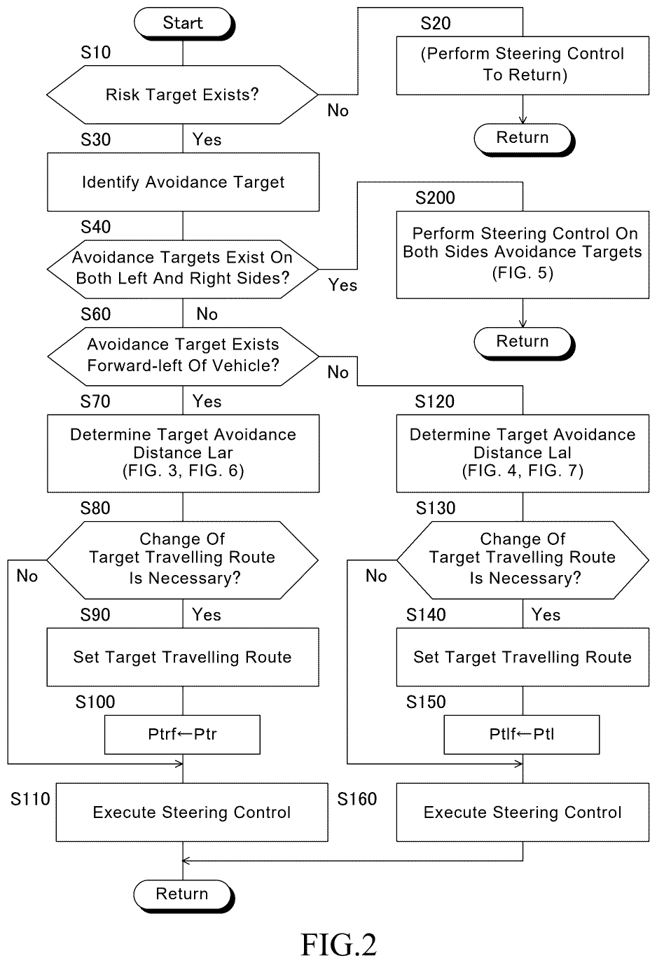

In the embodiment, the ROM of the driving assistance ECU 10 stores a driving assistance control program for collision avoidance corresponding to the flowcharts shown in FIGS. 2 to 5. The collision-avoidance driving assistance control program of the embodiment is a program for executing collision-avoidance driving assistance control in a country where vehicles travel on the left side of the road.

### Collision-Avoidance Driving Assistance Control (FIGS. 2 to 5)

Next, collision-avoidance driving assistance control in the embodiment will be described with reference to the flowcharts shown in FIGS. 2 to 5. The collision-avoidance driving assistance control according to the flowcharts shown in FIGS. 2 to 5 is repeatedly executed by the CPU of the driving assistance ECU 10 when the collision-avoidance driving assistance control switch is ON.

First, in step S10, the CPU determines, based on object information acquired by the object information acquisition device 18, whether an object (referred to as a “risk target”) such as a pedestrian, a bicycle, or another vehicle, which may collide (including contact) with the own vehicle, exists diagonally forward of the own vehicle 102. When an affirmative determination is made, the present control proceeds to step S30. When a negative determination is made, the present control proceeds to step S20.

In step S20, when a target travelling route has already been set, the CPU performs steering control to return a lateral position of the vehicle 102 relative to a road to a position before the target travelling route was set, thereby causing a travel path to return, and the present control is temporarily ended. When no target travelling route has been set, the present control is simply temporarily ended.

In step S30, the CPU identifies an avoidance target, that is, among the risk targets, a target that should be avoided by steering control. The avoidance target is a target satisfying predetermined requirements. The predetermined requirements may include, for example, that the target is within a range from a front end of the vehicle 102 forward by a reference distance Lxc (a positive constant) among the risk targets, and that a time to collision TTC is equal to or less than a reference value TTCc (a positive constant).

When only one risk target satisfies the predetermined requirements, that risk target is identified as the avoidance target. When a plurality of risk targets that satisfy the predetermined requirements exist on one of the left and right sides relative to the own vehicle, the risk target having the smallest TTC is identified as the avoidance target. When a plurality of risk targets that satisfy the predetermined requirements exist on both left and right sides relative to the own vehicle, the risk target having the smallest TTC on each side is identified as the avoidance target. Note that the time to collision TTC is a value obtained by dividing a distance Lr between the vehicle 102 and the risk target by a relative speed Vr.

In step S40, the CPU determines whether avoidance targets exist on both left and right sides relative to the own vehicle 102. When a negative determination is made, the present control proceeds to step S60. When an affirmative determination is made, the present control proceeds to step S200. In step S200, as will be described later in detail, avoidance distances Lar and Lal are determined for the avoidance targets on both left and right sides according to a subroutine shown in FIG. 5, and steering control for collision avoidance is performed based thereon.

In step S60, the CPU determines whether the avoidance target exists diagonally forward to the left of the vehicle 102, that is, whether the vehicle should avoid a collision by changing its traveling route rightward relative to the avoidance target. When a negative determination is made, the present control proceeds to step S120. When an affirmative determination is made, the present control proceeds to step S70.

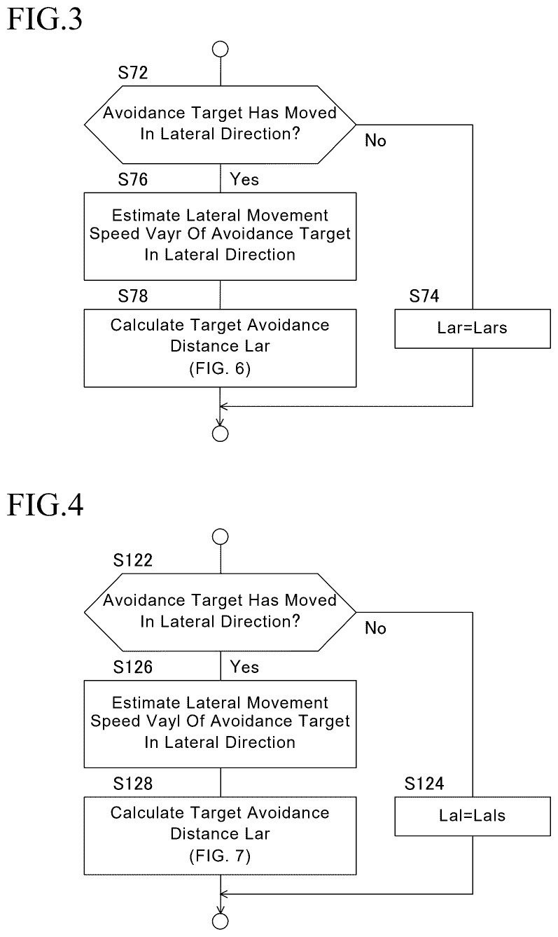

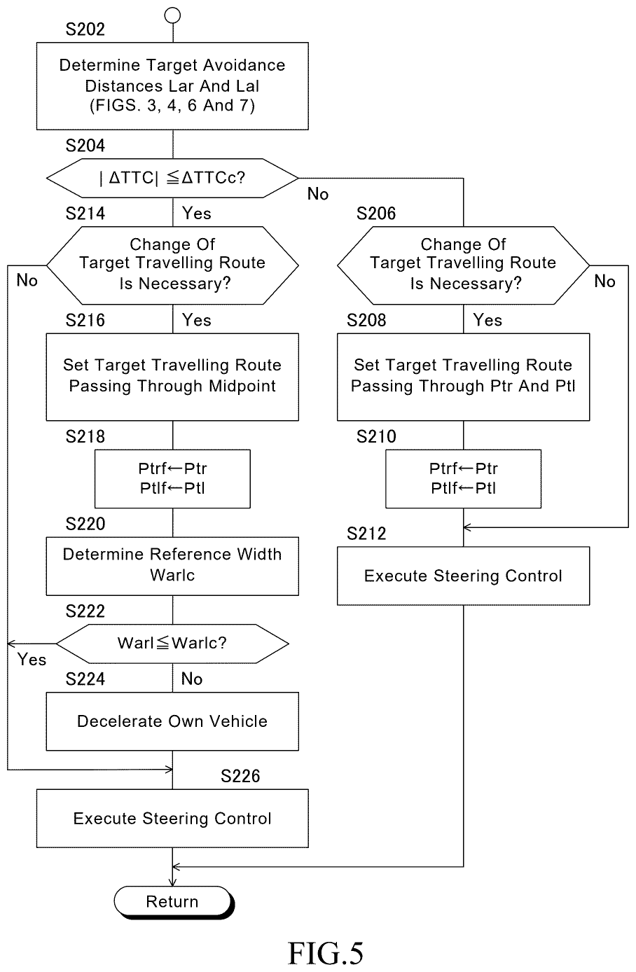

In step S70, as will be described later in detail, the CPU determines, according to a subroutine shown in FIG. 3, a target avoidance distance Lar that is a distance by which a target passing point Ptr of the vehicle 102 is separated rightward across a travel lane from the avoidance target. When the target avoidance distance Lar is determined, the target passing point Ptr is also determined as a position that is separated rightward across the travel lane from the avoidance target by the target avoidance distance Lar.

The target passing point Ptr is stored by storing, in the RAM, information on a relative position (relative direction and distance) of a reference position (e.g., a center of the front end) of the vehicle 102 with respect to the avoidance target, and is updated each time the target avoidance distance Lar is calculated.

In step S80, the CPU determines whether changing or setting of a target travelling route is necessary. When a negative determination is made, steps S90 and S100 are not executed and the present control proceeds to step S110. When an affirmative determination is made, the present control proceeds to step S90.

When no target travelling route has been set, an affirmative determination is made. Further, for example, an affirmative determination may be made when, due to movement of the avoidance target in a direction crossing the travel lane, a distance Lpry (not shown) in the direction crossing the travel lane between the target passing point Ptr of the vehicle 102 and a previous target passing point Ptrf is equal to or greater than a reference distance Lpryc (a positive constant). Further, even when the distance Lpry is less than the reference distance Lpryc, an affirmative determination may be made when, for example, a distance Lprx in a direction along the travel lane between the target passing point Ptr and the previous target passing point Ptrf is equal to or greater than a reference distance Lprxc (a positive constant). The previous target passing point Ptrf is the target passing point Ptr when the target travelling route of the vehicle was set previously.

In step S90, the CPU sets, in a manner known in the art, a target travelling route of the vehicle such that the reference position of the vehicle 102, for example, the center of the front end, passes through the target passing point Ptr by steering control. When the target travelling route of the vehicle has already been set, the target travelling route is reset.

In step S100, the CPU sets, as a previous target passing point Ptrf to be used in step S80 of the collision-avoidance driving assistance control in the Next cycle, the target passing point ptr of the current cycle.

In step S110, the CPU executes steering control that controls the automatic steering device 46 such that the reference position of the vehicle 102 moves along the target travelling route of the vehicle set in step S90.

In step S120, as will be described later in detail, the CPU determines, according to a subroutine shown in FIG. 4, a target avoidance distance Lal that is a distance by which a target passing point Ptl of the vehicle 102 is separated leftward across a travel lane from the avoidance target. When the target avoidance distance Lal is determined, the target passing point Ptl is also determined as a position separated leftward across the travel lane from the avoidance target by the target avoidance distance Lal.

The target passing point Ptl is also stored by storing, in the RAM, information on a relative position of the reference position of the vehicle 102 with respect to the avoidance target, and is updated each time the target avoidance distance Lal is calculated.

In step S130, the CPU determines whether changing or setting of a target travelling route is necessary. When a negative determination is made, steps S140 and S150 are not executed and the present control proceeds to step S160. When an affirmative determination is made, the present control proceeds to step S140.

When no target travelling route has been set, an affirmative determination is made. Further, for example, an affirmative determination may be made when, due to movement of the avoidance target in a direction crossing the travel lane, a distance Lply (not shown) in the direction crossing the travel lane between the target passing point Ptl of the vehicle 102 and a previous target passing point Ptlf is equal to or greater than a reference distance Lplyc (a positive constant). Further, even when the distance Lply is less than the reference distance Lplyc, an affirmative determination may be made when, for example, a distance Lplx in a direction along the travel lane between the target passing point Ptl and the previous target passing point Ptlf is equal to or greater than a reference distance Lplxc (a positive constant). The previous target passing point Ptlf is the target passing point Ptl when the target travelling route of the vehicle was set previously.

In step S140, the CPU sets, in a manner known in the art, a target travelling route of the vehicle such that the reference position of the vehicle 102 passes through the target passing point Ptl by steering control. When the target travelling route of the vehicle has already been set, the target travelling route is reset.

In step S150, the CPU sets, as a previous target passing point Ptlf to be used in step S130 of the collision-avoidance driving assistance control in the next cycle, the target passing point Ptl of the current cycle.

In step S160, the CPU executes steering control that controls the automatic steering device 46 such that the reference position of the vehicle 102 moves along the target travelling route of the vehicle set in step S140.

### Subroutine for Determining Avoidance Distance Lar (FIG. 3)

In step S72, the CPU determines whether the avoidance target has moved at least in a lateral direction of the travel lane. When a negative determination is made, the avoidance distance Lar is determined as a standard value Lars (a positive constant) in step S74. When an affirmative determination is made, the present control proceeds to step S76.

In step S76, the CPU estimates a lateral movement distance of the avoidance target based on the object information acquired by the object information acquisition device 18, and estimates a lateral movement speed Vayr of the avoidance target in the lateral direction of the travel lane by dividing the movement distance by a time of the control cycle.

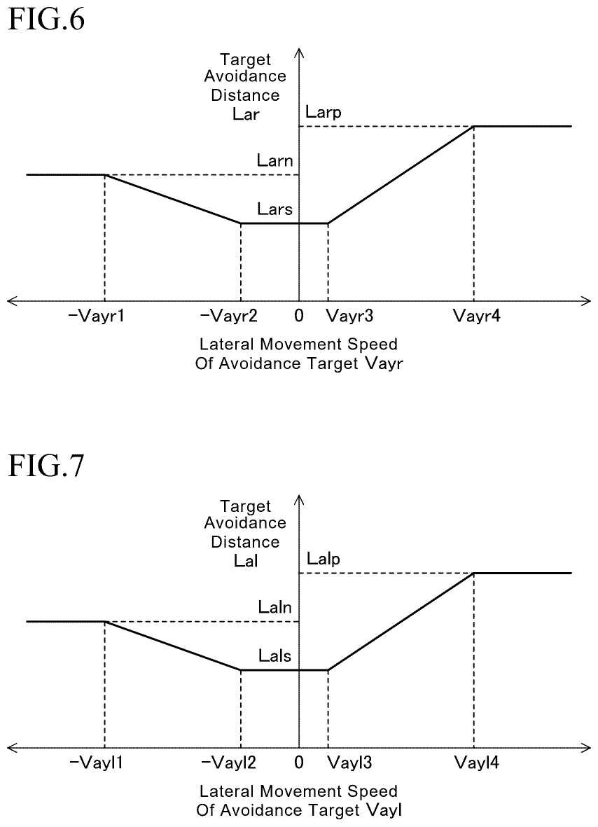

In step S78, the CPU calculates a target avoidance distance Lar from a map corresponding to a graph shown in FIG. 6 based on the movement speed Vayr of the avoidance target. The movement speed Vayr has a positive value when the avoidance target moves toward the opposite side of the travel lane (rightward), and has a negative value when the avoidance target moves away from the opposite side of the travel lane. The map is stored in the ROM of the driving assistance ECU 10, and Vayr1, Vayr2, Vayr3, and Vayr4 may be positive constants.

As shown in FIG. 6, when the movement speed Vayr is equal to or greater than −Vayr2 and equal to or less than Vayr3, the target avoidance distance Lar is the standard value Lars. When the movement speed Vayr is greater than Vayr4, the target avoidance distance Lar is a constant value Larp (a positive constant) greater than the standard value Lars. When the movement speed Vayr is greater than Vayr3 and equal to or less than Vayr4, the target avoidance distance Lar gradually increases from Lars to Larp as the movement speed Vayr increases.

When the movement speed Vayr is less than −Vayr1, the target avoidance distance Lar is a constant value Larn (a positive constant) that is greater than the standard value Lars and smaller than Larp. When the movement speed Vayr is less than −Vayr2 and equal to or greater than −Vayr1, the target avoidance distance Lar gradually increases from Lars to Larn as an absolute value of the movement speed Vayr increases.

In a range where the movement speed Vayr is less than −Vayr2 and equal to or greater than −Vayr1, an increase rate of the target avoidance distance Lar with respect to an increase in the absolute value of the movement speed Vayr is smaller than an increase rate of the target avoidance distance Lar with respect to an increase in the movement speed Vayr in a range where the movement speed Vayr is greater than Vayr3 and equal to or less than Vayr4. Except for a range where the movement speed Vayr is equal to or greater than −Vayr2 and equal to or less than Vayr3, for the same absolute value of the movement speed Vayr, the target avoidance distance Lar when the movement speed Vayr is positive is greater than the target avoidance distance Lar when the movement speed Vayr is negative.

### Subroutine for Determining Avoidance Distance Lal (FIG. 4)

In this subroutine, steps S122 to S128 are executed. Steps S122 to S128 are executed in the same manner as steps S72 to S78, respectively, except that left and right are reversed.

In step S122, the CPU determines whether the avoidance target has moved at least in the lateral direction of the travel lane. When a negative determination is made, the avoidance distance Lal is determined as a standard value Lals (a positive constant) in step S124. When an affirmative determination is made, the present control proceeds to step S126.

In step S126, the CPU estimates a lateral movement speed Vayl of the avoidance target in the lateral direction of the travel lane based on the object information acquired by the object information acquisition device 18, in the same manner as in step S76.

In step S128, the CPU calculates a target avoidance distance Lal from a map corresponding to a graph shown in FIG. 7 based on the movement speed Vayl of the avoidance target. The movement speed Vayl has a positive value when the avoidance target moves toward the opposite side of the travel lane (leftward), and has a negative value when the avoidance target moves away from the opposite side of the travel lane. This map is also stored in the ROM of the driving assistance ECU 10, and Vayl1, Vayl2, Vayl3, and Vayl4 may be positive constants.

As can be understood from a comparison between FIG. 7 and FIG. 6, the map corresponding to the graph shown in FIG. 7 is set in the same manner as the map corresponding to the graph shown in FIG. 6. Accordingly, a detailed description thereof is omitted. The movement speeds Vayl1 to Vayl4 correspond to the movement speeds Vayr1 to Vayr4, respectively, and the target avoidance distances Lals, Lalp, and Laln correspond to the target avoidance distances Lars, Larp, and Larn, respectively.

### Subroutine for Steering Control for Collision Avoidance for Avoidance Targets on Both Left and Right Sides (FIG. 5)

In step S202, the CPU determines, in the same manner as in step S70, a target avoidance distance Lar, which is a distance by which a target passing point Ptr of the vehicle 102 is separated rightward across the travel lane from a left side avoidance target. Further, the CPU determines, in the same manner as in step S120, a target avoidance distance Lal, which is a distance by which a target passing point Ptl of the vehicle 102 is separated leftward across the travel lane from a right side avoidance target. When a plurality of risk targets exist in front-and-rear positions on one side, the risk target closest to the own vehicle is treated as the avoidance target.

In step S204, the CPU determines whether an absolute value of a difference ΔTTC between a time to collision TTC for the left side avoidance target and a time to collision TTC for the right side avoidance target is equal to or less than a reference value ΔTTCc (a positive constant). When an affirmative determination is made, the present control proceeds to step S214. When a negative determination is made, the present control proceeds to step S206.

In step S206, the CPU determines, in the same manner as in steps S80 and S130, whether changing or setting of the target travelling route is necessary. When a negative determination is made, steps S208 and S210 are not executed and the present control proceeds to step S212. When an affirmative determination is made, the present control proceeds to step S208.

In step S208, the CPU sets, in the same manner as in steps S90 and S140, a target travelling route of the vehicle such that the reference position of the vehicle 102 passes through the target passing points Ptr and Ptl by steering control, in a manner known in the art.

In step S210, the CPU sets, as previous target passing points Ptrf and Ptlf to be used in step S206 of collision-avoidance driving assistance control or in step S214 described later in the next cycle, the target passing points Ptr and Ptl of the current cycle, respectively.

In step S212, the CPU executes steering control that controls the automatic steering device 46 such that the reference position of the vehicle 102 moves along the target travelling route of the vehicle set in step S208.

In step S214, the CPU determines, in the same manner as in step S206, whether changing or setting of the target travelling route is necessary. When a negative determination is made, steps S216 to S224 are not executed and the present control proceeds to step S226. When an affirmative determination is made, the present control proceeds to step S216.

In step S216, the CPU sets, in a manner known in the art, a target travelling route of the vehicle such that, in a section along the road between the left side and right side avoidance targets, the target travelling route passes through a midpoint between the target passing points Ptr and Ptl and extends along the road.

In step S218, the CPU sets, as previous target passing points Ptrf and Ptlf to be used in step S206 or step S214 of collision-avoidance driving assistance control in the next cycle, the target passing points Ptr and Ptl of the current cycle, respectively.

In step S220, the CPU determines a reference width Warlc, which is used for determination in step S222 described later, based on a width of the road and a width of the own vehicle. The reference width Warlc is determined such that the reference width becomes smaller as the road width becomes smaller and becomes smaller as the width of the own vehicle becomes larger.

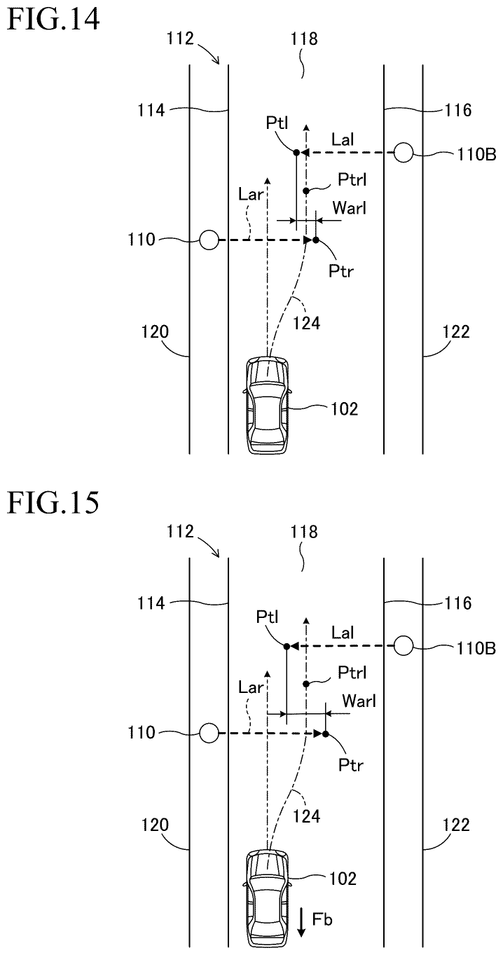

In step S222, the CPU determines whether a width Warl (see FIGS. 14 and 15), which is a width of overlap between ranges of the avoidance distances Lar and Lal calculated in step S202, is equal to or less than the reference width Warlc. When an affirmative determination is made, the present control proceeds to step S226. When a negative determination is made, the present control proceeds to step S224.

In step S224, the CPU outputs a command signal to the drive ECU 20 and the brake ECU 30 to decelerate the own vehicle. As necessary, a command signal may be output to the meter ECU 50 to activate the alarm device 54 and issue an alarm.

In step S226, the CPU executes steering control that controls the automatic steering device 46 such that the reference position of the vehicle 102 moves along the target travelling route of the vehicle set in step S216.

### Operation of the Embodiment

Next, operations of the embodiment will be described for various cases in which positions and situations of avoidance targets relative to the own vehicle differ.

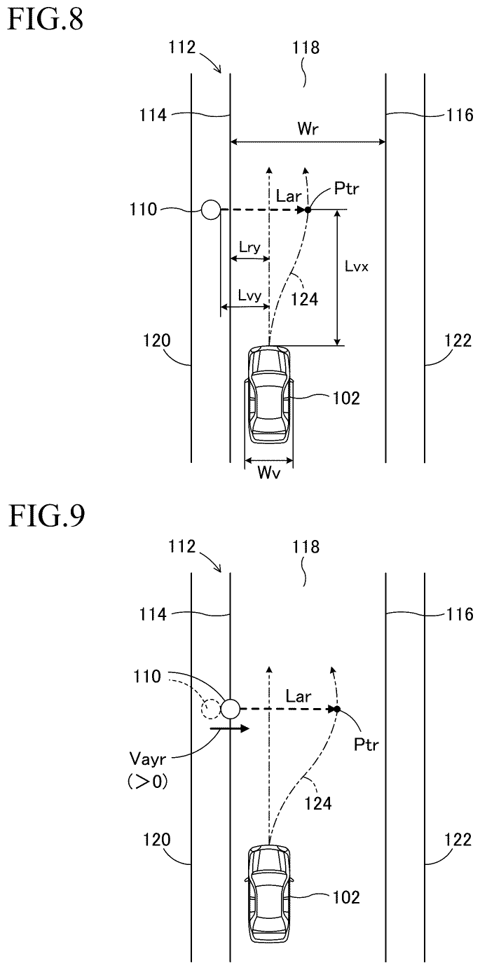

### (1) Case Where one Stationary Avoidance Target Exists Diagonally Forward to the Left of the own Vehicle (FIG. 8)

FIG. 8 illustrates a situation in which one stationary avoidance target 110 exists diagonally forward to the left of the own vehicle 102. As shown in FIG. 8, a distance along a road 112 between a reference position of the own vehicle 102 and the avoidance target 110 is denoted by Lvx, and a distance in a direction crossing the road is denoted by Lvy. In FIG. 8, reference numerals 114 and 116 denote white lane lines on the left and right sides of a roadway 118, respectively, and reference numerals 120 and 122 denote left and right boundaries of the road 112, respectively. Regions between the white lane lines 114 and 116 and the boundaries 120 and 122, respectively are shoulders. The roadway 118 may be one of a plurality of lanes, in which case the white lane line 116 may be a lane boundary.

In the situation shown in FIG. 8, an affirmative determination is made in step S10, a negative determination is made in step S40, and an affirmative determination is made in step S60. In step S70, a target avoidance distance Lar is determined. In this case, a negative determination is made in step S72 of step S70, and the target avoidance distance Lar is determined as the standard value Lars in step S74. An affirmative determination is made in step S80, a target travelling route 124 of the own vehicle 102 is set in step S90, and steering control is executed in step S110 such that the reference position of the own vehicle moves along the target travelling route.

Since a distance between the avoidance target 110 and the target passing point Ptr is the target avoidance distance Lar, a distance between the reference position of the own vehicle 102 and the target passing point Ptr is Lar−Lvy. Accordingly, the target travelling route 124 is set such that, when the reference position of the own vehicle 102 moves forward by a distance Lvx, the reference position smoothly moves rightward by the distance Lar−Lvy.

As shown in FIG. 8, a distance in the direction crossing the road between the left white lane line 114 and the reference position of the own vehicle 102 is denoted by Lry. A distance between the left white lane line 114 and the target passing point Ptr is Lar−Lvy+Lry.

Let Wr denote a width of the roadway 118, and let Wv denote a width of the own vehicle 102. A reference value based on the width Wv is denoted by Wvc, and the reference value Wvc increases as the width Wv increases. When a distance Wr−(Lar−Lvy+Lry) is equal to or less than the reference value Wvc, there is a possibility that the own vehicle may protrude rightward from the roadway 118 when traveling along the target travelling route.

Accordingly, after step S70 is completed, it is determined in step S80 whether the distance Wr−(Lar−Lvy+Lry) is equal to or less than the reference value Wvc. When an affirmative determination is made, steps S90 and thereafter may be executed, and the brake control device 36 may be controlled to decelerate the own vehicle. In addition to deceleration of the own vehicle, a command signal may be output to the meter ECU 50 to activate the alarm device 54 and issue an alarm indicating a possibility of protrusion. Such protrusion prevention control may also be performed in cases (2) to (5) described later.

### (2) Case Where one Avoidance Target Moving Rightward Exists Diagonally Forward to the Left of the own Vehicle (FIG. 9)

FIG. 9 illustrates a situation in which one avoidance target 110 moving rightward exists diagonally forward to the left of the own vehicle 102. Since the movement direction of the avoidance target is rightward, the lateral movement speed Vayr of the avoidance target has a positive value.

In the situation shown in FIG. 9, an affirmative determination is made in step S72 of step S70, and a target avoidance distance Lar is calculated in step S78 based on the positive movement speed Vayr. The target avoidance distance Lar is calculated such that the target avoidance distance increases as the movement speed Vayr increases. In other respects, collision avoidance steering control is performed in the same manner as in case (1) described above.

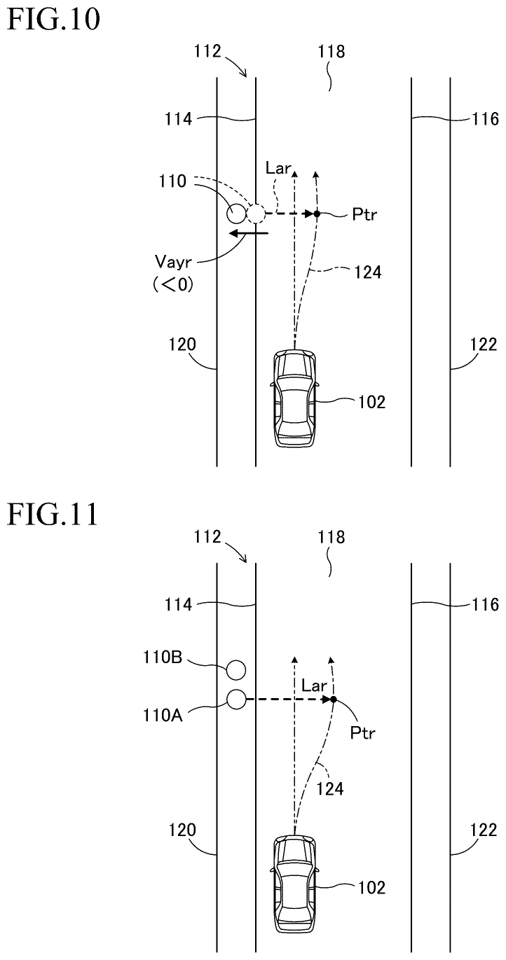

### (3) Case Where one Avoidance Target Moving Leftward Exists Diagonally Forward to the Left of the own Vehicle (FIG. 10)

FIG. 10 illustrates a situation in which one avoidance target 110 moving leftward exists diagonally forward to the left of the own vehicle 102. Since the movement direction of the avoidance target is leftward, the lateral movement speed Vayr of the avoidance target has a negative value.

In the situation shown in FIG. 10, an affirmative determination is made in step S72 of step S70, and a target avoidance distance Lar is calculated in step S78 based on the negative movement speed Vayr. The target avoidance distance Lar is calculated such that the target avoidance distance increases as an absolute value of the movement speed Vayr increases. In other respects, control is performed in the same manner as in case (1) described above.

### (4) Case Where two or More Avoidance Targets Exist Diagonally Forward to the Left of the own Vehicle (FIG. 11)

FIG. 11 illustrates a situation in which two stationary avoidance targets 110A and 110B exist in front-and-rear positions diagonally forward to the left of the own vehicle 102. In FIG. 11, the avoidance target 110A is located closer to the own vehicle 102 than the avoidance target 110B.

In the situation shown in FIG. 11, a time to collision TTC of the avoidance target 110A is smaller than a time to collision TTC of the avoidance target 110B. Accordingly, in step S30, the avoidance target 110A is identified as the avoidance target. Further, the collision avoidance steering control is performed with the avoidance target 110A treated as the avoidance target, in the same manner as in case (1) described above.

When the avoidance target 110A moves rightward, the collision avoidance steering control is performed for the avoidance target 110A in the same manner as in case (2) described above. When the avoidance target 110A moves leftward, the collision avoidance steering control is performed for the avoidance target 110A in the same manner as in case (3) described above.

Although not shown in the drawings, when two avoidance targets exist diagonally forward to the left of the own vehicle at the same distance from the own vehicle along the road, the collision avoidance steering control may be performed for the avoidance target closer to the own vehicle, that is, the avoidance target located on the right side, in the same manner as in case (1) described above.

Further, when one or more avoidance targets exist diagonally forward to the right of the own vehicle, a negative determination is made in step S60, and steps S120 to S150 are executed instead of steps S70 to S100, and the collision avoidance steering control is performed in the same manner as in the cases described above except that left and right are reversed.

### (5) Case Where two Avoidance Targets Exist Diagonally Forward on Both Left and Right Sides of the own Vehicle

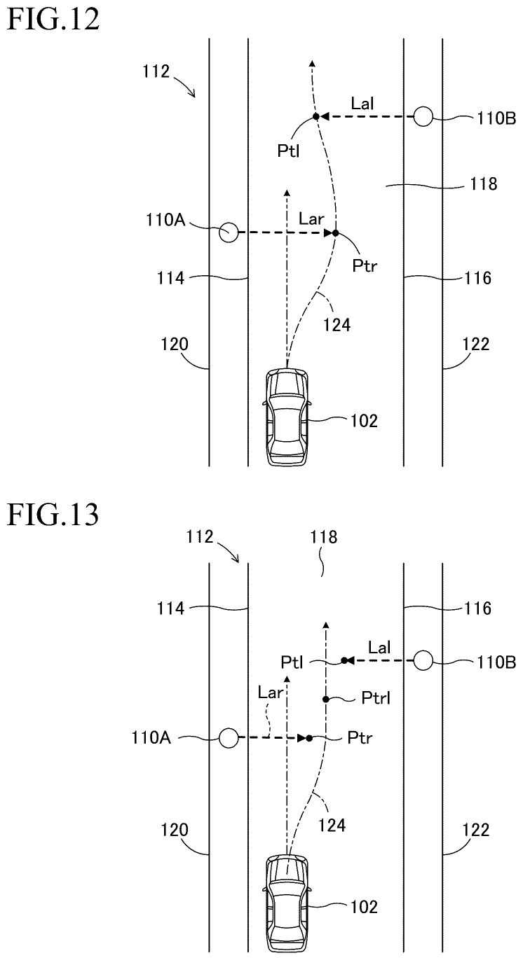

FIGS. 12 to 15 illustrate a situation in which one stationary avoidance target 110A exists diagonally forward to the left of the own vehicle 102 and one stationary avoidance target 110B exists diagonally forward to the right of the own vehicle 102. The avoidance target 110A is located closer to the own vehicle 102 than the avoidance target 110B. In FIGS. 12 to 15, a width of the roadway 118 is the same as that in FIGS. 8 to 11, but may be smaller than the latter.

In these cases, affirmative determinations are made in steps S10 and S40, and step S200 is executed. In step S200, control described below is performed according to the situation.

### (A) Case Where a Distance Along the Travel Lane Between two Avoidance Targets is Large (FIG. 12)

In FIG. 12, a time to collision TTC of the avoidance target 110A is smaller than a time to collision TTC of the avoidance target 110B, and an absolute value of a difference ΔTTC between the two times to collision TTC is greater than a reference value ΔTTCc (a positive constant).

A negative determination is made in step S204, an affirmative determination is made in step S206, and in step S208, a target travelling route 124 is set such that the target travelling route passes through the target passing point Ptr and further passes through the target passing point Ptl, thereby forming an S-shaped path. The travel path of the own vehicle is controlled such that the reference position of the own vehicle moves along the target travelling route 124.

### (B) Case Where a Distance Along the Road Between two Risk Targets is Small (FIGS. 13 to 16)

In FIGS. 13 to 15, as in the case of FIG. 12, a time to collision TTC of the avoidance target 110A is smaller than a time to collision TTC of the avoidance target 110B, but an absolute value of a difference ΔTTC between the two times to collision TTC is equal to or less than the reference value ΔTTCc. Accordingly, affirmative determinations are made in steps S204 and S214. In each of the cases shown in FIGS. 13 to 15, the travel path of the own vehicle is controlled such that the reference position of the own vehicle moves along the target travelling route 124.

### (B1) Case Where Ranges of Avoidance Distances Lar and Lal do not Overlap (FIG. 13)

In FIG. 13, the target passing points Ptr and Ptl are located on sides of the avoidance targets 110A and 110B, respectively, relative to the other target passing point. Accordingly, the ranges of the avoidance distances Lar and Lal do not overlap when viewed along the road 112.

As shown in FIG. 13, the target travelling route 124 is set such that, in a range along the road 112 between the target passing points Ptr and Ptl, the target travelling route passes through a midpoint Ptrl between the target passing points Ptr and Ptl and extends along the road 112.

### (B2) Case Where Ranges of Avoidance Distances Lar and Lal Slightly Overlap (FIG. 14)

In FIGS. 14 and 15, the target passing points Ptr and Ptl are located on sides of the avoidance targets 110B and 110A, respectively, relative to the other target passing point. Accordingly, the ranges of the avoidance distances Lar and Lal overlap when viewed along the road 112.

In particular, in FIG. 14, a width Warl of an overlapping range of the avoidance distances Lar and Lal is equal to or less than a reference width Warlc that is set such that the reference width becomes smaller as a width Wv of the own vehicle becomes larger and becomes smaller as a width Wr of the road 112 becomes smaller.

As shown in FIG. 14, the target travelling route 124 is set, as in case (B1), such that, in a range along the road 112 between the target passing points Ptr and Ptl, the target travelling route passes through the midpoint Ptrl between the target passing points Ptr and Ptl and extends along the road 112.

### (B3) Case Where Ranges of Avoidance Distances Lar and Lal Largely Overlap (FIG. 15)

In FIG. 15, the width Warl of the overlapping range of the avoidance distances Lar and Lal is greater than the reference width Warlc.

As shown in FIG. 15, also in this case, the target travelling route 124 is set in the same manner as in cases (B1) and (B2). However, in order to prevent the own vehicle 102 from contacting the avoidance target 110A and/or 110B, the brake control device 36 is controlled to apply a braking force Fb to the own vehicle, thereby decelerating the own vehicle and, as necessary, stopping the own vehicle. In addition to deceleration or stopping of the own vehicle, a command signal may be output to the meter ECU 50 to activate the alarm device 54 and issue an alarm indicating a possibility of contact with the avoidance targets.

In any of cases (A), (B1), and (B2), when the avoidance target moves and the target passing point Ptr and/or Ptl changes by at least a reference distance in the lateral direction of the road 112, the target travelling route 124 is reset so as to pass through the changed target passing points.

In FIGS. 12 to 15, the avoidance target 110A is located closer to the own vehicle 102 than the avoidance target 110B. However, when the avoidance target 110B is located closer to the own vehicle 102 than the avoidance target 110A, control similar to that in each of the cases described in (5) is performed except that left and right are reversed.

### (6) Case Where two Risk Targets Exist Diagonally Forward on Both Left and Right Sides of the own Vehicle

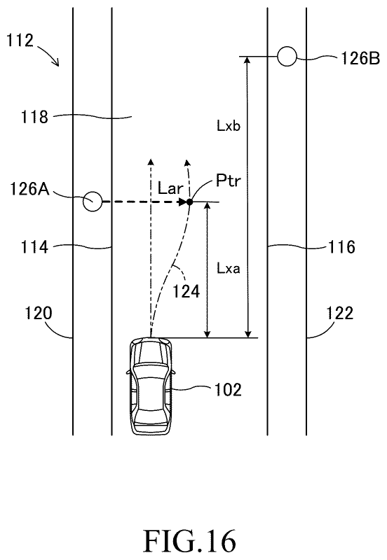

FIG. 16 illustrates a situation in which one stationary risk target 126A exists diagonally forward to the left of the own vehicle 102 and one stationary risk target 126B exists diagonally forward to the right of the own vehicle 102. The risk target 126A satisfies the predetermined requirements and is therefore an avoidance target, whereas the risk target 126B is located far from the own vehicle and does not satisfy the predetermined requirements and is therefore not an avoidance target.

Accordingly, as in case (1) described above, a target travelling route 124 is set so as to pass through the target passing point Ptr. The travel path of the own vehicle is controlled such that the reference position of the own vehicle moves along the target travelling route 124.

When the reference position of the own vehicle passes through the target passing point Ptr and the risk target 126B comes to satisfy the predetermined requirements, the risk target 126B is identified as an avoidance target. Accordingly, the target travelling route 124 is reset so as to pass through the target passing point Ptl (not shown in FIG. 16) determined based on the risk target 126B.

### Effects of the Embodiment

As described above, according to the embodiment, when it is determined that the target passing points Ptr and Ptl have changed by at least reference distances Lpryc and Lplyc, respectively, in at least the lateral direction of the road 112 relative to the positions at which the target travelling route 124 was set previously (S80, S130), the target travelling route is reset so as to pass through the changed target passing points (S90, S140). Accordingly, when the avoidance target 110 moves by at least a distance corresponding to the reference distance in at least the lateral direction of the road, the target travelling route can be reset. Therefore, it is possible to prevent an occupant or occupants of the own vehicle from feeling anxiety due to inappropriate avoidance of the avoidance target caused by the target travelling route not being reset even though the avoidance target has moved by at least the distance corresponding to the reference distance in at least the lateral direction of the road.

Further, as compared to where the target passing point is determined and the target travelling route is reset at each predetermined control cycle, a frequency of resetting the target travelling route can be reduced, thereby reducing a computational load of the driving assistance ECU 10 as a control unit required to set the target travelling route.

Further, the target passing point Ptr or Ptl at the time of previously setting the target travelling route 124 is a point on the currently set target travelling route, and whether resetting of the target travelling route is necessary is determined based on a movement distance of the points. Accordingly, determination as to whether resetting of the target travelling route is necessary can be easily performed as compared to where whether resetting of the target travelling route is necessary is determined based on a change in position of the avoidance target.

When an obstacle exists on a planned travel path of the own vehicle, such as when an avoidance target moves onto the planned travel path of the own vehicle, known collision-prevention control in the art may be executed to perform automatic braking or steering control so that the own vehicle does not collide with the obstacle.

Further, according to the embodiment, when it is determined that a plurality of avoidance targets (risk targets 126A, 126B) exist on one of the left and right sides relative to the own vehicle 102, a target passing point is determined for the avoidance target having the smallest time to collision TTC (S30). Accordingly, a target passing point can be determined for the avoidance target with which a collision is most likely to occur first, and the target travelling route can be set so as to pass through the target passing point.

Further, according to the embodiment, when avoidance targets exist on both left and right sides relative to the own vehicle 102 (S40), and when the difference ΔTTC in time to collision is greater than the reference value ΔTTCc (S204), target passing points Ptr and Ptl are determined for the avoidance targets on both sides, and the target travelling route is set so as to pass through the two determined target passing points (S208). Accordingly, a target travelling route for the own vehicle to travel while avoiding the avoidance targets on both sides can be set.

Further, according to the embodiment, when the difference ΔTTC in time to collision is equal to or less than the reference value ΔTTCc and the width Warl of overlap between the ranges of the target avoidance distances Lar and Lal is equal to or less than the reference width Warlc (S222), the target travelling route 124 is set so as to pass through the midpoint Ptrl between the two target passing points Ptr and Ptl and extend along the road 112 in a range between the two target passing points (S216). Accordingly, a target travelling route that avoids the avoidance targets on both sides as much as possible can be set to extend along the road without sharply weaving.

Further, according to the embodiment, when the width Warl of overlap between the ranges of the target avoidance distances Lar and Lal is greater than the reference width Warlc (S222), the target travelling route 124 is set so as to pass through the midpoint Ptrl between the two target passing points Ptr and Ptl and extend along the road 112 in a range between the two target passing points (S216), and the own vehicle is decelerated (S224). Accordingly, it is possible to set a target travelling route that avoids the avoidance targets on both sides as much as possible while extending along the road without sharply weaving, and also to prevent the own vehicle from approaching the avoidance targets at a high vehicle speed or colliding therewith.

Further, according to the embodiment, when a movement direction of the avoidance target 110 is a direction approaching the opposite side of the road, the target avoidance distances Lar and Lal are increased as compared with when the movement direction of the avoidance target is a direction moving away from the opposite side of the road (S72 to S78, S122 to S128). Accordingly, it is possible to effectively avoid a collision with the avoidance target by increasing the target avoidance distance when the avoidance target moves in the direction approaching the opposite side of the road, without excessively increasing the target avoidance distance when the avoidance target moves in the direction moving away from the opposite side of the road.

Further, according to the embodiment, the lateral movement speed Vayr or Vayl of the avoidance target in the lateral direction of the road 112 is estimated (S76, S126), and the target avoidance distance Lar or Lal is variably set according to the movement speed such that the target avoidance distance increases as the movement speed increases (S78, S128). Accordingly, it is possible to effectively avoid a collision with the avoidance target without delay by increasing the target avoidance distance when the movement speed of the avoidance target is large, without excessively increasing the target avoidance distance when the movement speed is small.

Further, according to the embodiment, when the movement direction of the avoidance target is a direction moving away from the opposite side of the road, the target avoidance distance is variably set such that an increase rate of the target avoidance distance with respect to an increase in movement speed is smaller than when the movement direction of the avoidance target is a direction approaching the opposite side of the road. Accordingly, when the movement direction of the avoidance target is a direction moving away from the opposite side of the road, it is possible to reduce a possibility that the occupant or occupants of the own vehicle feel anxiety that the own vehicle will approach the avoidance target too closely, and when the movement direction is a direction approaching the opposite side of the road, it is possible to move the target travelling route away from the avoidance target without delay.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above-described embodiment, in steps S80, S130, and the like, determination as to whether changing or setting of the target travelling route is necessary is made based on whether a distance in the direction crossing the travel lane between the target passing point of the vehicle 102 and the previous target passing point is equal to or greater than the reference distance. However, determination as to whether changing or setting of the target travelling route is necessary may be made based on whether a distance in the direction crossing the travel lane between a current position of the avoidance target and a previous position thereof is equal to or greater than a reference distance.

Further, in the above-described embodiment, when a negative determination is made in step S204, steps S206 to S212 are executed. However, steps S204 to S212 may be omitted.

Further, in the above-described embodiment, in step S220, the reference width Warlc is variably set such that the reference width becomes smaller as the road width becomes smaller and becomes smaller as the width of the own vehicle becomes larger. However, the reference width Warlc may be constant, or may be variably set according to only one of the road width and the width of the own vehicle.

Further, in the above-described embodiment, in steps S70 and S120 and the like, the target passing point is determined as a position separated from the avoidance target by the target avoidance distance in the direction crossing the travel lane and is stored in the RAM. However, the target passing point may be stored in the RAM as a position separated by the target avoidance distance in the direction crossing the travel lane from a boundary of the road or lane corresponding to the avoidance target.

Further, in the above-described embodiment, in the situation shown in FIG. 12, that is, when two avoidance targets exist diagonally forward on both left and right sides and an absolute value of the difference ΔTTC between the times to collision TTC of the two avoidance targets is greater than the reference value, the target travelling route is set so as to pass through both target passing points. However, the target travelling route may be set so as to pass through both target passing points when the absolute value of the difference ΔTTC is greater than the reference value and the width Warl of overlap between the ranges of the avoidance distances Lar and Lal is equal to or less than another reference value Warls that is smaller than the reference width Warlc. Further, when the road width is large and the ranges of the avoidance distances Lar and Lal do not overlap, the target travelling route may be set in the same manner as in the case of FIG. 13.

Further, in the above-described embodiment, the road 112 has no center line. However, the driving assistance apparatus of the present disclosure also functions in the same manner in roads having a center line and roads having a plurality of lanes on one side.

Further, the above-described embodiment is configured to be applied to a country where vehicles travel on the left side of a road. However, the driving assistance apparatus of the present disclosure may be configured to be applied to a country where vehicles travel on the right side of a road, in which case left and right are reversed from those in the embodiment.

What is claimed is:

1. A vehicle driving assistance apparatus comprising:
an object information acquisition device configured to repeatedly acquire object information ahead of an own vehicle; and
an electronic control unit configured to, when the electronic control unit determines based on the information acquired by the object information acquisition device that an avoidance target to be avoided by collision avoidance exists within a predetermined range diagonally forward of the own vehicle, determine a target passing point laterally spaced from the avoidance target by a target avoidance distance for avoiding a collision, set a target travelling route to pass through the target passing point, and execute driving assistance control to perform steering control such that the own vehicle travels along the target travelling route,
wherein the electronic control unit is configured such that, when the electronic control unit determines that the target passing point has changed by at least a reference distance in at least a lateral direction of a road relative to a position at which the target travelling route was set previously, the electronic control unit resets the target travelling route so as to pass through the changed target passing point.

2. The vehicle driving assistance apparatus according to claim 1, wherein, the electronic control unit is configured to, when the electronic control unit determines that a plurality of avoidance targets exist on one of left and right sides relative to the own vehicle, determine the target passing point for an avoidance target having a smallest time to collision among time to collisions calculated based on distances and relative speeds between the own vehicle and the plurality of avoidance targets.

3. The vehicle driving assistance apparatus according to claim 1, wherein the electronic control unit is configured such that, when the electronic control unit determines that avoidance targets exist on both left and right sides relative to the own vehicle, the electronic control unit determines target passing points for the avoidance targets on both sides and sets the target travelling route to pass through the two determined target passing points, when a difference in time to collision calculated based on a distance and a relative speed between the own vehicle and the avoidance targets on both sides is greater than a reference value.

4. The vehicle driving assistance apparatus according to claim 3, wherein the electronic control unit is configured to determine the target passing points for the avoidance targets on both sides, when the difference in time to collision is equal to or less than the reference value, and the electronic control unit is further configured to set the target travelling route so as to pass through a midpoint between the two determined target passing points and, in a region between the two target passing points, extend along the road, when a width of overlap between ranges of the target avoidance distances for the avoidance targets on both sides is equal to or less than a reference width determined based on a width of the road and a width of the own vehicle.

5. The vehicle driving assistance apparatus according to claim 4, wherein the electronic control unit is configured to set the target travelling route so as to pass through the midpoint between the two determined target passing points and, in the region between the two target passing points, extend along the road, and to decelerate the own vehicle, when the width of overlap between the ranges of the target avoidance distances for the avoidance targets on both sides is greater than the reference width.

6. The vehicle driving assistance apparatus according to claim 1, wherein the electronic control unit is configured to determine, based on the information acquired by the object information acquisition device, a movement direction of the avoidance target in a lateral direction of the road, and to increase the target avoidance distance when the movement direction of the avoidance target is a direction approaching an opposite side of the road, as compared with when the movement direction of the avoidance target is a direction moving away from the opposite side of the road.

7. The vehicle driving assistance apparatus according to claim 6, wherein the electronic control unit is configured to estimate, based on the information acquired by the object information acquisition device, a movement speed of the avoidance target in the lateral direction of the road, and to variably set the target avoidance distance according to the movement speed such that the target avoidance distance increases as the movement speed increases.

8. The vehicle driving assistance apparatus according to claim 7, wherein the electronic control unit is configured to variably set the target avoidance distance according to the movement direction and the movement speed of the avoidance target such that an increase rate of the target avoidance distance with respect to an increase in the movement speed is smaller than when the movement direction of the avoidance target is a direction approaching the opposite side of the road, when the movement direction of the avoidance target is a direction moving away from the opposite side of the road.
